(19) United States
(12) Patent Application Publication
(10) Pub. No.: US 2026/0091846 A1
(43) Pub. Date: Apr. 2, 2026

(54) GEAR-SHIFTING DEVICE FOR MOBILITY VEHICLE

(71) Applicant: VALEO EMBRAYAGES, Amiens (FR)

(72) Inventors: Jerome Boulet, St Quentin Fallavier (FR); Emmanuel Pastor, St Quentin Fallavier (FR)

(73) Assignee: VALEO EMBRAYAGES, Amiens (FR)

(21) Appl. No.: 19/110,343

(22) PCT Filed: Sep. 8, 2023
(86) PCT No.: PCT/EP2023/074732

§ 371 Date: Mar. 10, 2025

(30) Foreign Application Priority Data
Sep. 9, 2022 (FR) FR2209082
Sep. 9, 2022 (FR) FR2209083

(51) Int. Cl. B62M 25/08; B62M 6/55; B62M 11/06

(52) U.S. Cl. CPC B62M 25/08; B62M 11/06; B62M 6/55

(57) ABSTRACT

A gear-shifting device for a mobility machine is disclosed herein. The gear-shifting device includes a selection shaft in which are arranged a shuttle, a worm screw, and a guide tube in which the worm screw is positioned.

The present invention relates to the field of gearshift devices and more particularly to a gearshift device for a mobility machine using at least electrical propulsion and, for example, to an electrically assisted bicycle.

When a mobility machine is in operation, a motive force is transmitted to the wheels via a crank system turning about an axis of a crankset that drives the rear wheel, generally via a chain.

Gearboxes for mobility machine are already known from the prior art. For example, patent FR2913661 discloses a gearshift device for bicycles that has a gearbox with gears and a sliding shuttle for selecting the gear ratio.

The shuttle acts on a system of pawls which in turn act on input pinions for engaging the selected gear. The disadvantage with this system of the prior art stems from the fact that the shuttle is imperfectly guided.

The object of the present invention is therefore to overcome one or more of the disadvantages of the devices of the prior art by proposing an improved gearshift device.

For that purpose, the present invention proposes a gearshift device for a mobility machine, comprising a selection shaft in which there are arranged a shuttle, a worm screw, and a guide tube in which the worm screw is positioned.

According to one embodiment of the invention, one of the ends of the tube is inserted in a rotation-blocking element so that the shuttle can be prevented from rotating.

According to one embodiment of the invention, the guide tube is formed by two blades arranged longitudinally with respect to the worm screw and one on each side thereof.

According to one embodiment of the invention, the two blades are arranged about the worm screw at between 45 degrees and 180 degrees along the length thereof.

According to one embodiment of the invention, the length of the guide tube is determined such that the worm screw is fully inserted therein.

According to one embodiment of the invention, the length of the guide tube is identical to that of the worm screw.

According to one embodiment of the invention, a first end of the guide tube is in the form of a ring ending in a slot-shaped cutout.

According to one embodiment of the invention, the slots collaborate with those of at least one anti-rotation washer fixed to the selection shaft.

According to one embodiment of the invention, the second end of the guide tube is formed by a second ring inserted into an opening formed in a rotation-blocking element.

According to one embodiment of the invention, the rotation-blocking element is formed by a washer.

According to one embodiment of the invention, the rotation-blocking element comprises, at its center, an opening into which the ends of the guide tube and of the worm screw are inserted.

According to one embodiment of the invention, the rotation-blocking element is arranged radially with respect to the worm screw.

According to one embodiment of the invention, the rotation-blocking element has a diameter greater than that of the selection shaft so as to ensure the stability of the rotation blocking. According to one embodiment of the invention, the rotation-blocking element has at least one external cutout and/or at least one internal cutout.

According to one embodiment of the invention, the external cutout is formed at the external edge of the rotation-blocking element so as to form a tab that is offset relative to the radial plane of the blocking element.

According to one embodiment of the invention, the internal cutout is positioned between the external edge of the rotation-blocking element and the central opening thereof and is produced in such a way as to form a tab that is offset relative to the radial plane of the rotation-blocking element.

According to one embodiment of the invention, the rotation-blocking element is forcibly press-fitted into a suitable housing in the cover of the gearbox of the machine.

The invention also relates to a mobility machine, notably an electrically assisted mobility machine, having a gearshift device according to the invention.

Further aims, features and advantages of the invention will be understood better and will become more clearly apparent from reading the description given below with reference to the appended figures, which are given by way of example and in which:

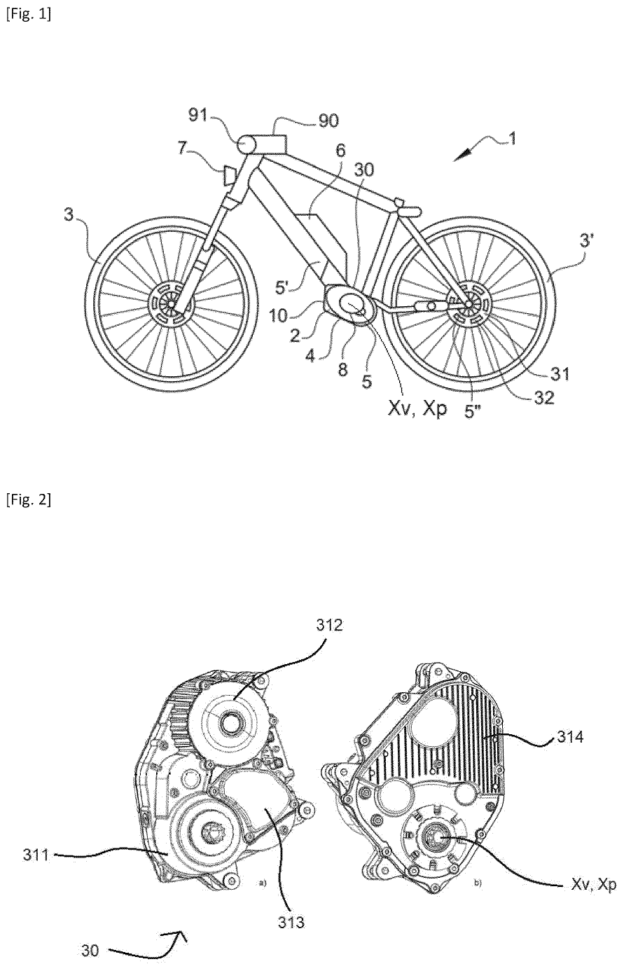

FIG. 1 is an overall view of a mobility machine according to one of the aspects of the invention,

FIG. 2 is a view in elevation of the gearbox comprising the transmission assembly of the mobility machine of FIG. 1: 2a) from a first face, and 2b) from a second face,

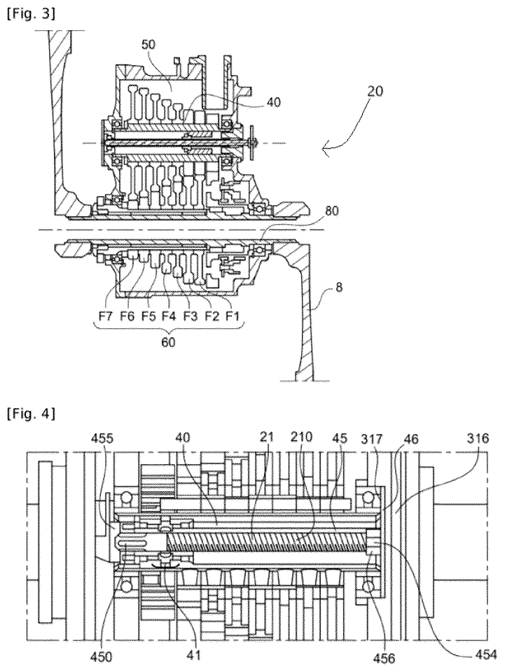

FIG. 3 is a view in cross section of the transmission assembly according to the invention,

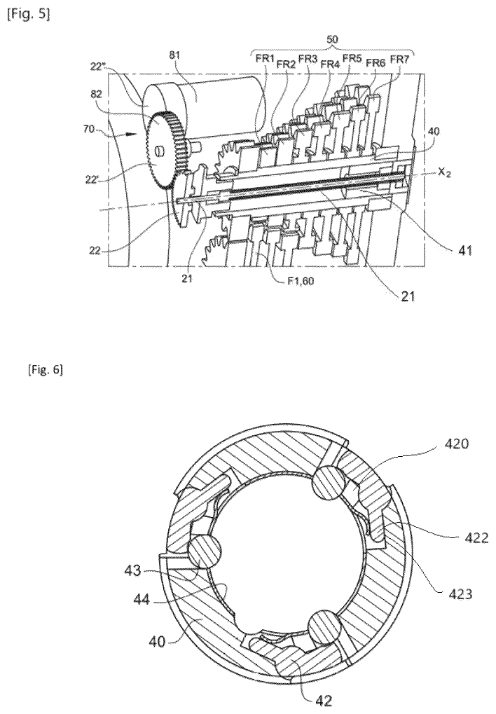

FIG. 4 is a view in cross section of a gearshift device according to the invention,

FIG. 5 is a cross-sectional view in elevation of the gearshift device according to the invention,

FIG. 6 is a view in cross section of the shaft of the transmission assembly according to the invention,

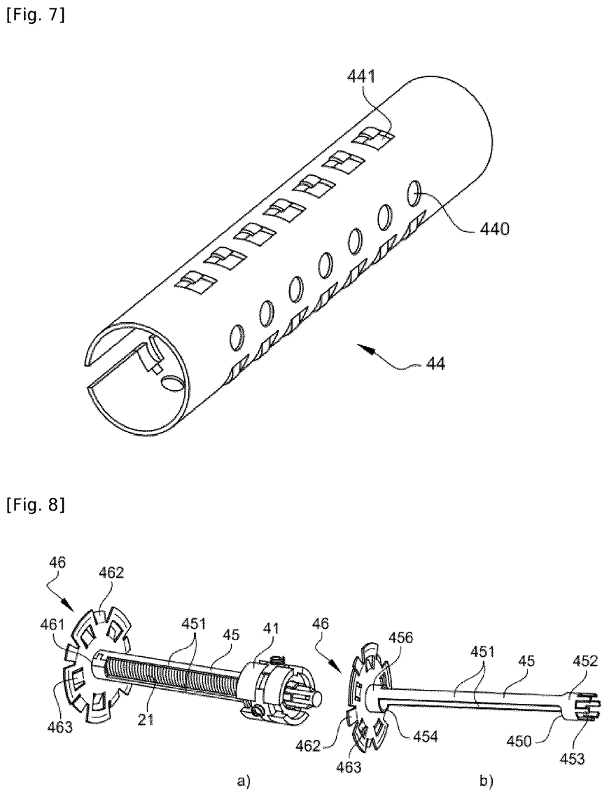

FIG. 7 is a view in elevation of the retaining ring according to the invention,

FIG. 8 is a view in elevation of the rotation-blocking element and of the guide tube according to the invention: 8a) with the shuttle, and 8b) without the shuttle,

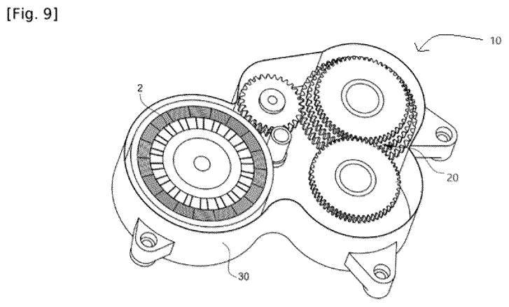

FIG. 9 is a view in cross section of the inside of the gearbox comprising the transmission assembly according to the invention.

[FIG. 1] illustrates a mobility machine 1 according to one of the aspects of the invention. The machine 1 here is an electrically assisted bicycle comprising an electric motor 2. The electric motor 2 is designed to provide some of the propulsion of the machine.

The bicycle comprises at least two wheels 3, 3′ to which a motive force is supplied via two pedals or equivalent turning about an axis of a crankset of axis Xp which drives the rear wheel, for example via a chain, or any other transmission means during its use.

The machine 1 also comprises a control unit 4 and a plurality of sensors 5, 5′, 5″, situated for example at the crankset, on the frame of the bicycle or at a wheel 3, 3′.

The machine 1 shown here also comprises an energy storage device in the form of a battery 6, a lighting system 7, a crankset 8 of axis Xp, a location and/or navigation system 90 and a human-machine interface system 91 notably comprising a touchscreen able to display information for and/or to take into account the requirements of said user. The human-machine interface system 91 is in particular connected to the location system 90 and serves as navigation interface. The invention is not limited to a particular human-machine interface system, and can comprise any system known to a person skilled in the art.

The wheels 3, 3′ are provided with a brake system 31, notably comprising disk brakes 32.

The machine 1 has a transmission assembly 10, illustrated in FIG. 3. The transmission assembly 10 has a gearshift device 20 according to the invention and the electric motor 2 for supplying some of the power for propelling the machine 1.

According to one embodiment of the invention, the transmission assembly 10 is at least in part accommodated in a gearbox 30 closed by a cover 314 (illustrated in [FIG. 2]) here positioned at the crankset 8, the axis Xp of which is coincident with the output axis Xᵥ of the gearshift device 20.

According to one embodiment of the invention, the gearshift device 20 illustrated in [FIG. 3] to [FIG. 5] has at least 2 gear ratios, and for example 7 gear ratios between a first gear ratio called 1st gear and a higher gear ratio called 7th gear.

According to one embodiment of the invention, the gearshift device 20 comprises a series of seven output pinions 60 of axis X_{,}, namely pinions referenced F₁ to F₇, rotating as one with a hollow shaft 80, and a series of seven input pinions 50, namely pinions referenced FR₁ to FR₇, designed to turn freely about the selection shaft 40.

According to one embodiment of the invention, the selection shaft 40 illustrated in [FIG. 4] arranges a shuttle 41 surrounding a worm screw 21 of the gearshift device 20.

According to one variant of the invention, the gearshift device 20 comprises a planetary gearset.

The machine 1 according to the invention comprises a gearshift actuator 70 designed to move the shuttle 41 along the worm screw 21 by a helical kinematic connection, between at least 2 positions and for example between 7 positions from P₁ to P₇ and to engage a selected gear ratio.

According to one embodiment of the invention, the selection shaft 40 is hollow.

According to one embodiment of the invention, the gearshift actuator 70 comprises electrical means for moving the shuttle 41, in the form of a reduction gearset. This reduction gearset comprises a motor 81 and a reducer 82.

According to one embodiment of the invention, the reduction gearset also comprises a pinion 22 on the axis of the worm screw 21, an intermediate pinion 22′ and a pinion 22″′ on the axis Xm of the motor 81. The toothsets of the pinions 22, 22′, 22″ can be straight-cut teeth as illustrated or helical teeth in a variant which is not illustrated.

According to one embodiment of the invention, the reduction gearset comprises pinions having parallel axes as illustrated in [FIG. 3] or having perpendicular axes.

According to one embodiment of the invention, the gearshift actuator 70 comprises a bevel gearset, straight-cut spur gearset or a helical gearset and/or has one or more stages.

According to one variant embodiment of the invention, the gearshift actuator 70 has a belt or a chain or a universal joint or pinions.

The rotational guidance of the worm screw 21 is, for example, ensured by means of rolling bearings at each of its ends.

According to one embodiment of the invention, the shuttle 41 is configured such that, during its movement, it is positioned below the pinion of the selected gear ratio and engages this gear ratio.

According to one embodiment of the invention, the shuttle 41 is configured like the one described in application FR2975367.

According to one embodiment of the invention, the gearshift device 20 comprises, at the selection shaft 40, at least two pawls 42 and, for example, for a 7-speed machine 1, comprises seven pawls 42.

According to one embodiment of the invention, the gearshift device 20 comprises a series of seven pawls positioned one after the other along the longitudinal axis X2 of the selection shaft 40.

According to one embodiment of the invention, the gearshift device 20 comprises at least one series of at least seven pawls positioned one after the other along the longitudinal axis X2 of the selection shaft 40.

According to one embodiment of the invention, the gearshift device 20 comprises three series of at least seven pawls positioned one after the other along the longitudinal axis X2 of the selection shaft 40. The series being spaced 120 degrees from one another about the selection shaft 40.

The pawls 42 have a shape configured to collaborate with the input pinions FRi. The pawls 42 are inserted into recesses 420 formed on the selection shaft 40 via one of the ends 422. This end is fully inserted into the housing so as to be pressed intimately against the upper face 423 of the housing 420. Each pawl 42 is associated with a lifter device, and for example a ball 43, visible in [FIG. 4] and [FIG. 6], housed in a drilling 430 in the selection shaft 40, protruding into the inside of the shaft 40, and positioned beneath each pawl 42 so as to be able to lift it via the shuttle 41.

When the gear is selected, the shuttle 41 is positioned beneath the input pinion FRᵢ corresponding to the gear ratio i selected, which is then prevented from rotating by one of the pawls 42 and meshes with the corresponding output pinion.

According to one embodiment of the invention, the pawls 42 are held in place by a retaining ring 44 illustrated in [FIG. 6] and [FIG. 7].

According to an embodiment of the invention, the ring is made of an elastic material. According to one embodiment of the invention, the ring 44 is made of pressed spring steel. According to another embodiment of the invention, the ring 44 is made of plastic. This retaining ring 44 is positioned inside the selection shaft 40. The ring 44 forms a cylinder pressed intimately, inside the selection shaft 40, against the internal surface of the selection shaft 40. Retention is thus achieved from inside the selection shaft 40.

According to one embodiment of the invention, the ring is open in the longitudinal direction. The length of the ring 44 is determined such that the entire set of pawls 42 are held in place.

According to one embodiment of the invention, the retaining ring 44 has openings 440 that collaborate with the balls 43 positioned under the pawls. The retaining ring 44 thus enables the balls 43 to be held in place.

According to one embodiment of the invention, the retaining ring 44 comprises at least two tabs 441 formed from the ring 44. More specifically, the tabs 441 are formed by the cutting-out, pressing or bending, or by any other process that enables a tab shape to be obtained on the retaining ring 44. According to one embodiment, the retaining ring 44 comprises as many tabs 441 as there are pawls 42.

Each tab 441 is arranged beneath a pawl 4 at that part 422 of the pawl 42 that is inserted in the housing 420 formed in the selection shaft 40.

The retaining ring 44 thus enables the pawl to be held in the closed position. To do that, the retaining ring 44 applies to each pawl 42, via the tabs, a pressure, or pressing force, that is enough to press the pawl 42 firmly into the housing 420 while allowing it to be lifted by the shuttle 41. The pressing force is defined such as to counter the centrifugal effect on the pawl 42.

What that means to say is that each tab 441 presses on the end 422 of the pawl which is thus pressed firmly against the upper face 423 of the housing 420, the other end 424 of the pawl thus being free to be lifted by the ball 43 through a pivot effect.

According to one embodiment of the invention, the retaining ring 44 comprises at least one series of seven tabs 441 positioned one after the other along the longitudinal axis X2 of the selection shaft 40, under each pawl 42.

According to one embodiment of the invention, the gearshift device 20 comprises three series of at least seven tabs 441 positioned one after the other along the longitudinal axis X2 of the selection shaft 40. The series being spaced 120 degrees from one another about the selection shaft 40.

According to one embodiment of the invention, the retaining ring 44 comprises at least one series of seven openings 440 positioned one after the other along the longitudinal axis X2 of the selection shaft 40, under each ball 43.

According to one embodiment of the invention, the gearshift device 20 comprises three series of at least seven openings 440 positioned one after the other along the longitudinal axis X2 of the selection shaft 40. The series being spaced 120 degrees from one another about the selection shaft 40.

According to one embodiment of the invention, the series of tabs 441 and of openings 440 are intercalated in the radial direction of the retaining ring 44.

When the machine is being used, the shuttle 41 makes it possible to select the chosen gear ratio, which will engage an input pinion FRi via a pawl 42.

The input pinion FRi then meshes with an output pinion Fi.

If the machine 1 is running in a gear ratio i, without changing gear, the worm screw 21 does not turn.

During a change of gear ratio, the worm screw 21 is driven in rotation by the gearshift actuator 70 causing the axial movement of the nut 210 of the worm screw 21 which drives the shuttle 41 and thus allows the gearshift. The pivot connection thus implemented converts the rotational movement of the worm screw 21 into translational movement of the shuttle 41.

According to one embodiment of the invention, a stop limits, at each end, the movement of the shuttle 41. According to another embodiment of the invention, the movement of the shuttle is controlled by a position sensor.

In an embodiment which has not been illustrated, the shuttle 41 can adopt a position referred to as the neutral position P0 in which no gear ratio is engaged.

In the context of the invention, the worm screw 21 is positioned in a guide tube 45 visible in [FIG. 4]. The guide tube serves to guide the shuttle 41 along the worm screw 21.

According to one embodiment of the invention, the guide tube 45 is formed by two blades 451 also referred to as rails. The two blades 451 are arranged longitudinally with respect to the worm screw 21 and one on each side thereof. According to one embodiment of the invention, the two blades are arranged about the worm screw 21 at between 45 degrees and 180 degrees along the length thereof.

According to one embodiment of the invention, the length of the guide tube 45 is determined such that the worm screw 21 is fully inserted therein.

According to one embodiment of the invention, the length of the guide tube 45 is identical to that of the worm screw 21. According to one embodiment of the invention, a first end 450 of the guide tube 45 is in the form of a ring 452 ending in a slot-shaped cutout 453.

According to one embodiment of the invention, these slots 453 collaborate with those of at least one anti-rotation washer 455 fixed to the selection shaft 40. This washer 455 is fixed in terms of rotation and is configured so that the worm screw 21 rotates without driving it.

According to one embodiment of the invention, the second end 454 of the guide tube 45 is formed by a second ring 456 inserted into an opening 461 formed in a rotation-blocking element 46.

According to one embodiment of the invention, the second ring 454 is accommodated in an anti-rotation element 47, for example of the washer type.

According to one embodiment of the invention, the rotation-blocking element 46 is formed by a washer. According to one embodiment of the invention, the washer comprises, at its center, an opening 461 into which the ends of the guide tube 45 and of the worm screw 21 are inserted. The rotation-blocking element 46 is arranged radially with respect to the worm screw 21, namely is arranged perpendicular to the axes Xv and Xp of the machine 1.

According to one embodiment of the invention, the rotation-blocking element 46 has a diameter greater than that of the selection shaft 40 so as to ensure the stability of the rotation blocking.

According to one embodiment of the invention, the rotation-blocking element 46 has at least one external cutout 462 and/or at least one internal cutout 463.

According to one embodiment of the invention, the external cutout 462 is formed at the external edge of the rotation-blocking element 46. The cutout is produced in such a way as to form a tab 462. The tab 462 is offset with respect to the radial plane of the blocking element 46 outward, namely in a direction parallel to the axis of the worm screw 21 and away from the worm screw.

According to one embodiment of the invention, the internal cutout 463 is situated between the external edge of the rotation-blocking element 46 and the central opening 461 thereof. The cutout is produced in such a way as to form a tab 463. The tab 463 is offset with respect to the radial plane of the blocking element 46 outward, namely in the same direction as the direction in which the external tab 462 is offset.

According to one embodiment of the invention, the rotation-blocking element 46 has at least two external tabs 462 and at least two internal tabs 463. The internal tabs 462 and external tabs 463 are arranged in such a way as to be intercalated with one another.

According to one embodiment of the invention, the rotation-blocking element 46 has five external tabs 462 and five internal tabs 463. The internal tabs 462 and external tabs 463 are arranged in such a way as to be intercalated with one another, as visible in [FIG. 8].

This set of tabs provides the rotation-blocking element 46 with a certain degree of elasticity to make it possible to avoid breakage of the set as a result of vibration for example.

According to one embodiment of the invention, the rotation-blocking element 46 is press-fitted into a suitable housing 317 in the cover of the gearbox 30. The rotation-blocking element 46 is held firmly in the housing by virtue of the elasticity of the tabs. The size of the housing is defined in such a way as to allow the rotation-blocking element 46 to be forcibly inserted into it. Thus, the rotation-blocking element 46 is able to block the rotation of the guide tube 45 through the effects of friction and pressure. The rotation-blocking element 46 is also able to center the guide tube 45 and thus all the other elements.

[FIG. 9] illustrates in greater detail the gearbox 30 of the mobility machine 1 of FIG. 1 comprising the transmission assembly according to the invention.

According to one embodiment of the invention, the gearbox comprises a first housing 311 designed to house the gears of the gearshift device 20, and at least two housings 312, 313 distinct from one another and designed to respectively house the electric motor and the gearshift actuator.

According to one embodiment of the invention, the gearbox 30 is open on one side.

According to one embodiment of the invention, this side is closed by a cover 314.

The scope of the present invention is not limited to the details given above and allows embodiments in numerous other specific forms without moving away from the field of application of the invention. Consequently, the present embodiments should be considered by way of illustration, and may be modified without, however, departing from the scope defined by the claims.

1. A gearshift device for a mobility device, comprising a selection shaft in which there are arranged a shuttle, a worm screw, and a guide tube in which the worm screw is positioned.

2. The gearshift device as claimed in claim 1, wherein one of a plurality of ends of the guide tube is inserted in a rotation-blocking element so that the shuttle can be prevented from rotating.

3. The gearshift device as claimed in claim 1, wherein the guide tube is formed by two blades arranged longitudinally with respect to the worm screw and one on each side thereof.

4. The gearshift device as claimed in claim 3, wherein the two blades are arranged about the worm screw at between 45 degrees and 180 degrees along a length thereof.

5. The gearshift device as claimed in claim 1, wherein a length of the guide tube is determined such that the worm screw is fully inserted therein.

6. The gearshift device as claimed in claim 1, wherein the length of the guide tube is identical to that of the worm screw (21).

7. The gearshift device as claimed in claim 1, wherein a first end of the guide tube is in the form of a ring ending in a slot-shaped cutout.

8. The gearshift device as claimed in claim 7, wherein the slot-shaped cutout collaborates with those of at least one anti-rotation washer fixed to the selection shaft.

9. The gearshift device as claimed in claim 1, wherein a second end of the guide tube is formed by a second ring inserted into an opening formed in a rotation-blocking element.

10. An electrically assisted mobility machine, having the gearshift device as claimed in claim 1.
